(19) United States
(12) Patent Application Publication
(10) Pub. No.: US 2024/0054578 A1
(43) Pub. Date: Feb. 15, 2024

(54) System and Method for Food Preparation Management

(71) Applicant: Jason Quiroga, Dallas, TX (US)

(72) Inventor: Jason Quiroga, Dallas, TX (US)

(21) Appl. No.: 17/885,512

(22) Filed: Aug. 10, 2022

(51) Int. Cl. G06Q 50/12; G06Q 10/10; G06Q 30/06

(52) U.S. Cl. CPC G06Q 50/12; G06Q 10/1097; G06Q 30/0605; G06Q 30/0635; G06Q 10/083

(57) ABSTRACT

The present disclosure describes techniques for managing food preparation by a restaurant for online food orders. The techniques include the step of receiving at least one food order from at least one consumer over an online food delivery platform. The techniques further include the step of determining a time period for preparing the at least one food order based on an estimated preparation time of the at least one food item present in the at least one food order, receiving order pickup information associated with the at least one order, wherein the order pickup information comprises one or more of: order pickup time, GPS location information of the consumer, and GPS location information of a delivery agent, determining whether to start preparation of the at least one order based on time period for preparing the at least one food order and order pickup information. The techniques further include the step of initiating the preparation of the at least one order if a time left for pickup matches the time period for preparing the at least one food order, and/or the consumer or the delivery agent enters in a predefined radius of the restaurant.

### CROSS-REFERENCE TO RELATED APPLICATION

This application claims the benefit of U.S. Provisional Patent Application No. 63/231,704, filed Aug. 10, 2021, which is incorporated by reference herein in its entirety.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates generally to food preparation management systems, and more specifically, to a system and method for managing food preparation at a restaurant to enhance consumer experience.

### 2. Description of Related Art

This background information is intended to further educate the reader as to additional aspects of the prior art and may present examples of specific aspects of the prior art that is not to be construed as limiting the disclosure of the present application.

Due to the great increase in the cognizance of the internet and the technologies associated with it, several prospects are coming up on the web. So many businesses and companies now venture into their business with ease because of the internet. One such business that the internet introduced is an online food ordering system.

Online food ordering is the process of ordering food, for delivery or pickup, from mobile applications and web applications. The product can be either ready-to-eat food (e.g., direct from a home-kitchen, restaurant, or a ghost kitchen) or food that has not been specially prepared for direct consumption (e.g., vegetables direct from a farm/garden, fruits, frozen meats. etc).

In today's age of fast food and take out, many restaurants have chosen to focus on quick preparation and speedy delivery or pickup of orders rather than offering a rich dining experience. Until recently, most of these delivery orders were placed over the phone, but there are many disadvantages to this system.

Typically, the restaurants provide both takeout services and delivery services of food order to their customers in several discrete steps. First, a customer places the food order comprising food items and quantity of the food items with a restaurant. The restaurant receives the food order from the customer and provides an acknowledgement to the customer. Then, the restaurant starts the preparation of the food order.

The prepared food order is packaged and the customer or a driver (delivery agent) associated with a food delivery company reaches the restaurant to pick up the packaged food order. Most commonly fast food and fast casual restaurants take 3 to 10 minutes to prepare the food order. However, the restaurants do not know how much time the customer or the driver may take to reach the restaurant to pick up the food order.

Hence, the restaurants usually prepare the food order for the customer once the order is placed. As a result, there is a possibility that the customer or the driver may reach the restaurant before his/her food order is prepared and the customer or the driver may have to wait at the restaurant for some time to receive the food order.

Further, there is also a possibility that the restaurant may have prepared the food order long before the customer or the driver reaches the restaurant to pick up the food order. Thus, inevitable cooling may occur in the prepared food order over time. Also, many food items may experience a commensurate breakdown in texture, taste and consistency over time. For example, a restaurant serving chicken nuggets may be hot and crispy, but the same chicken nuggets may become soggy, cold and limp by the time the customer or the driver reaches the restaurant. This reduces consumer confidence in the restaurant and online food ordering/delivery system.

For the aforementioned reasons, there exists a need in the art to provide a technique which overcomes the above-mentioned problems and provides an efficient and effective system and method for managing food preparation at a restaurant.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In one non-limiting aspect of the present disclosure, a method of managing food preparation by a restaurant for online food orders is disclosed. The method comprises receiving at least one food order from at least one consumer over an online food delivery platform, the at least one food order comprising at least one food item and quantity of the at least one food item. The method further comprises determining a time period for preparing the at least one food order based on an estimated preparation time of the at least one food item present in the at least one food order, receiving order pickup information associated with the at least one food order, wherein the food order pickup information comprises one or more of: order pickup time, GPS location information of the consumer, and GPS location information of a delivery agent, determining whether to start preparation of the at least one food order based on time period for preparing the at least one food order and food order pickup information, and initiating the preparation of the at least one food order if: a time left for pickup matches the time period for preparing the at least one food order, and/or the consumer or the delivery agent enters in a predefined radius of the restaurant.

In another non-limiting aspect of the present disclosure, each of the at least one food item is mapped with an estimated preparation time by the restaurant.

In another non-limiting aspect of the present disclosure, receiving at least one food order comprises displaying a plurality of restaurants along with respective available food items, selecting the restaurant, the at least one food item, and the quantity of the at least one food item by the consumer via a mobile application, making a payment for the selected at least one food item, and generating a quick response (QR) code for the at least one food order after the payment is received.

In yet another non-limiting aspect of the present disclosure, receiving food order pickup information comprises displaying at least order pickup/delivery option to the consumer, wherein the at least order pickup/delivery option comprises at least one of: consumer pickup and one or more available delivery agent, selecting one of the order pickup/delivery options by the consumer, in response to selecting a consumer pickup option, receiving an order pickup time and/or GPS location information of the consumer, and in response to selecting a delivery agent option, receiving GPS location information of the delivery agent that accepts a food delivery request.

In yet another non-limiting aspect of the present disclosure, the method further comprises transmitting the QR code for the at least one food order to the consumer or the delivery agent based on the order pickup/delivery option selected by the consumer.

In yet another non-limiting aspect of the present disclosure, the predefined radius of the restaurant is determined based on the time period for preparing the at least one food order.

In yet another non-limiting aspect of the present disclosure, initiating the preparation of the at least one food order comprises notifying the restaurant for starting the preparation of the at least one food order if the time left for pickup matches the time period for preparing the at least one food order, and/or if the consumer or the delivery agent enters in a predefined radius of the restaurant, and notifying the consumer about the preparation of the at least one food order.

In yet another non-limiting aspect of the present disclosure, the method further comprises notifying a pickup point from one or more pickup points to the consumer/delivery agent after the at least one food order is ready for pickup, wherein the one or more pickup points may be a specific location, curbside at specific numbered parking spots, or drive-thru.

In yet another non-limiting aspect of the present disclosure, the method further comprises analyzing the one or more details associated with the at least one food order placed by the consumer to determine consumer preferences, generating one or more recommendations for the consumer based on the determined consumer preferences, and displaying the one or more recommendations on a mobile application.

In yet another non-limiting aspect of the present disclosure, the method further comprises authenticating the consumer/delivery agent at the pickup point based on a QR code transmitted to the consumer/delivery agent and releasing the at least one food order to the consumer/delivery agent based on the authentication.

In yet another non-limiting aspect of the present disclosure, a computing system for managing food preparation by a restaurant for online food orders is disclosed. The system comprises a memory for storing a plurality of instructions, and a processing unit in communication with the memory capable of executing the plurality of instructions. The computing system further comprises a user interface in communication with the memory and the processing unit. The user interface configured to receive at least one food order from at least one consumer over an online food delivery platform, the at least one food order comprising at least one food item and quantity of the at least one food item, and receive order pickup information associated with the at least one order, the order pickup information comprising one or more of: order pickup time, GPS location information of the consumer, and GPS location information of a delivery agent. The processing unit is configured to determine a time period for preparing the at least one food order based on an estimated preparation time of the at least one food item present in the at least one food order, determine whether to start preparation of the at least one food order based on time period for preparing the at least one food order and order pickup information, and initiate the preparation of the at least one food order if: a time left for pickup matches the time period for preparing the at least one food order, and/or the consumer or the delivery agent enters in a predefined radius of the restaurant.

In yet another non-limiting aspect of the present disclosure, to receive at least one food order, the user interface comprising a display unit is configured to display a plurality of restaurants along with respective available food items, and receive a selection of the restaurant, the at least one food item, and the quantity of the at least one food item by the consumer via a mobile application. The processing unit is configured to execute a payment for the selected at least one food item and generate a quick response (QR) code for the at least one food order after the payment is received.

In yet another non-limiting aspect of the present disclosure, to receive order pickup information, the user interface comprising a display unit is configured to display at least order pickup/delivery option to the consumer, wherein the at least order pickup/delivery option comprises at least one of: consumer pickup and one or more available delivery agent, receive a selection of one of the order pickup/delivery options by the consumer. In response to selection of the consumer pickup option, the user interface is further configured to receive an order pickup time and/or GPS location information of the consumer and in response to selection of the delivery agent option, the user interface is further configured to receive GPS location information of the delivery agent that accepts a food delivery request.

In yet another non-limiting aspect of the present disclosure, the computing system further comprises a transceiver configured to transmit the QR code for the at least one food order to the consumer or the delivery agent based on the order pickup/delivery option selected by the consumer.

In yet another non-limiting aspect of the present disclosure, the processing unit is configured to determine the predefined radius of the restaurant based on the time period for preparing the at least one food order.

In yet another non-limiting aspect of the present disclosure, to initiate the preparation of the at least one food order, the processing unit is configured to notify the restaurant to start the preparation of the at least one food order, if the time left for pickup matches the time period for preparing the at least one food order, and/or if the consumer or the delivery agent enters in a predefined radius of the restaurant, and notify the consumer about the preparation of the at least one food order.

In yet another non-limiting aspect of the present disclosure, the processing unit is configured to notify a pickup point from one or more pickup points to the consumer/delivery agent after the at least one food order is ready for pickup, wherein the one or more pickup points may be a specific location, curbside at specific numbered parking spots, or drive-thru.

In yet another non-limiting aspect of the present disclosure, the processing unit is configured to analyze the one or more details associated with the at least one food order placed by the consumer to determine consumer preferences, generate one or more recommendations for the consumer based on the determined consumer preferences, and display, via display unit of the user interface, the one or more recommendations on a mobile application.

In yet another non-limiting aspect of the present disclosure, the computing system further comprises a scanning device configured to authenticate the consumer/delivery agent at the pickup point based on a QR code transmitted to the consumer/delivery agent, wherein the at least one food order is released to the consumer/delivery agent based on the authentication.

In yet another non-limiting aspect of the present disclosure, a non-transitory computer-readable medium having computer-readable instructions is disclosed. The computer-readable instructions when executed by a processor causes the processor to perform operations of obtaining at least one food order from at least one consumer over an online food delivery platform, wherein the at least one food order comprises at least one food item and quantity of the at least one food item, determining a time period for preparing the at least one food order based on an estimated preparation time of the at least one food item present in the at least one food order, obtaining order pickup information associated with the at least one order, wherein the order pickup information comprises one or more of: order pickup time, GPS location information of the consumer, and GPS location information of a delivery agent, determining whether to start preparation of the at least one food order based on time period for preparing the at least one food order and order pickup information, and initiating the preparation of the at least one food order if: a time left for pickup matches the time period for preparing the at least one food order, and/or the consumer or the delivery agent enters in a predefined radius of the restaurant.

The foregoing summary is illustrative only and is not intended to be in any way limiting. In addition to the illustrative aspects, and features described above, further aspects, and features will become apparent by reference to the drawings and the following detailed description.

### BRIEF DESCRIPTION OF THE DRAWINGS

The accompanying drawings, which are incorporated in and constitute a part of this disclosure, illustrate exemplary aspects and, together with the description, serve to explain the disclosed principles. Some aspects of system and/or methods in accordance with aspects of the present subject matter are now described, by way of example only, and with reference to the accompanying Figures, in which:

FIG. 1 shows an exemplary environment capable of managing food preparation by restaurants for online food orders, in accordance with an aspect of the present disclosure;

FIG. 2 illustrates an exemplary communication environment between consumers/delivery agents and restaurants, in accordance with some aspects of the present disclosure;

FIG. 3 is a block diagram illustrating an exemplary consumer interaction for placing online food orders, in accordance with an aspect of the present disclosure;

FIG. 4 shows an exemplary environment for tracking real-time GPS location of the consumers/delivery agents, in accordance with an aspect of the present disclosure;

FIG. 5 is a block diagram illustrating a computing system for managing food preparation by restaurants for online food orders, in accordance with an aspect of the present disclosure;

FIG. 6 is a block diagram illustrating a system for managing food preparation by restaurants for online food orders, in accordance with an aspect of the present disclosure;

FIG. 7 depicts a flowchart illustrating an exemplary method of managing food preparation by restaurants for online food orders, in accordance with an aspect of the present disclosure;

FIG. 8 shows an exemplary dashboard of an administrator of the computing system that maintains an online food ordering/delivery system, in accordance with an aspect of the present disclosure;

FIG. 9(a)-(e) shows an exemplary application flow for restaurant manager for managing food preparation at a restaurant, in accordance with an aspect of the present disclosure; and

FIG. 10(a)-(j) an exemplary application flow for a consumer accessing an online food ordering platform, in accordance with an aspect of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any aspect or implementation of the present subject matter described herein as “exemplary” is not necessarily to be construed as preferred or advantageous over other aspects.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an aspect”, “in another aspect” and similar language throughout this specification may, but not necessarily do, all refer to the same aspect.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client or server computer system) configured by an application may constitute a “module” (or “subsystem”) that is configured and operated to perform certain operations. In one aspect, the “module” or “subsystem” may be implemented mechanically or electronically, so a module includes dedicated circuitry or logic that is permanently configured (within a special-purpose processor) to perform certain operations. In another aspect, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

The terms “food”, “food order”, “food item”, “food delivery”, “food preparation” or any other variations thereof should be understood to include consumable substances both edible and drinkable such as beverages, both alcoholic and non-alcoholic that may be consumed together with food.

The present disclosure describes techniques for managing food preparation by a restaurant for online food orders. The techniques include the step of receiving at least one food order from at least one consumer over an online food delivery platform. The techniques further include the step of determining a time period for preparing the at least one food order based on an estimated preparation time of the at least one food item present in the at least one food order, receiving order pickup information associated with the at least one order, wherein the order pickup information comprises one or more of: order pickup time, GPS location information of the consumer, and GPS location information of a delivery agent, determining whether to start preparation of the at least one order based on time period for preparing the at least one food order and order pickup information. The techniques further include the step of initiating the preparation of the at least one food order if a time left for pickup matches the time period for preparing the at least one food order, and/or the consumer or the delivery agent enters in a predefined radius of the restaurant.

Thus, the above-mentioned technique facilitates timely delivery/pickup of an order to a consumer ordering the food from the restaurant online without experiencing a commensurate breakdown in texture, taste and consistency of the food item.

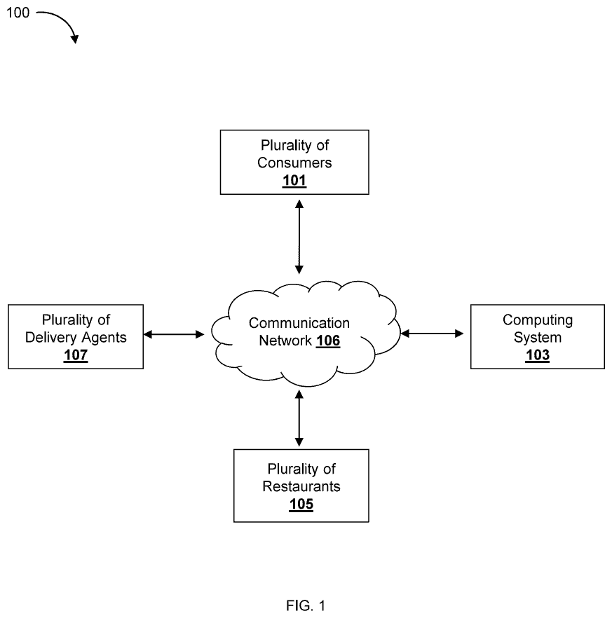

FIG. 1 shows an exemplary environment capable of managing food preparation by restaurants for online food orders, in accordance with an aspect of the present disclosure.

FIG. 1 is a block diagram illustrating an exemplary environment 100 capable of managing food preparation at a restaurant, in accordance with an aspect of the present disclosure. According to FIG. 1, the environment 100 comprises a plurality of consumers 101, a plurality of delivery agents 107, and a plurality of restaurants 105 communicatively connected to a computing system 103 through a communication network 106.

In an aspect of the present disclosure, the plurality of consumers 101, plurality of delivery agents 107, and the plurality of restaurants 105 also have respective one or more electronic devices for connecting to the computing system 103. In an exemplary aspect of the present disclosure, the one or more electronic devices may be a tablet computer, smartphone and the like.

In an aspect, a consumer may place an order one or more food items from a restaurant of his/her choice through the computing system 103 that manages food preparation by restaurants. The delivery agents 107 may pick-up the food order from a restaurant on behalf of the consumer and deliver the food order to the consumer.

In an exemplary aspect of the present disclosure, the communication network 106 may be the internet. The computing system 103 may be a central server, such as a cloud server or a remote server. Further, the one or more electronic devices may include a mobile/web application to access the computing system 103 via the communication network 106.

In an exemplary aspect of the present disclosure, the mobile application may work with Linga software. The mobile application may support Android platforms, iOS platforms or the like. The mobile application may also be used with existing restaurant applications. The mobile application may require integration with other restaurant platforms to ensure expansion. The consumers 101 may use the computing system 103 to place a food order and pay for the food order via the mobile application. Further, the consumers 101 may also use the computing system 103 to receive one or more notifications corresponding to the food order via the mobile application installed on their respective device. However, the scope of the present disclosure is not limited to the above example and a consumer/delivery agent may also place the order and interact with the computing system 103 through a web application.

In an exemplary aspect of the present disclosure, the plurality of restaurants 105 may comprise restaurant systems that are connected to the communication network 105 through a laptop computer, desktop computer, tablet computer, smartphone, wearable device, smart watch and the like. The restaurant system may be used by restaurant managers, restaurant admins and the like. Further, the restaurants may use a web browser and a mobile application to access the computing system 103 via the communication network 106.

In an aspect of the present disclosure, the restaurant may use a web application through the web browser to access the computing system 103 and receive one or more notifications to prepare the food order for the consumer. Further, the computing environment 100 also includes a restaurant printer (not shown) associated with the restaurant communicatively coupled to the computing system 103 via the communication network 106. The restaurant printer 110 prints an order ticket corresponding to the food order. The computing system 103 may comprise a plurality of modules. Details on the plurality of modules have been elaborated in subsequent paragraphs of the present description.

In an aspect of the present disclosure, the computing system 103 receives a food order comprising one or more food items and quantity of the one or more food items from the consumer. Further, the computing system 103 determines time taken by the restaurant to prepare the food order based on estimated preparation time set by the restaurant for each food item present in the food.

The computing system 103 may also track a present GPS location of the consumer/delivery agent via Global Positioning System (GPS) while the consumer/delivery agent is arriving at the restaurant and determine whether the consumer or the driver has crossed a threshold location. The threshold location is a location from which the time taken by the consumer/delivery agent to reach the restaurant is the same as the determined time taken by the restaurant to prepare the food order. In one non-limiting aspect, the threshold location is at a predefined radius from the restaurant which is determined based on the time period for preparing the at least one food order. Furthermore, the computing system 103 notifies the restaurant to start preparing the food order upon determining that the consumer/delivery agent has crossed the threshold location or has entered the predefined radius of the restaurant.

This facilitates timely delivery/pickup of the order to a consumer ordering the food from the restaurant online without experiencing a commensurate breakdown in texture, taste and consistency of food item.

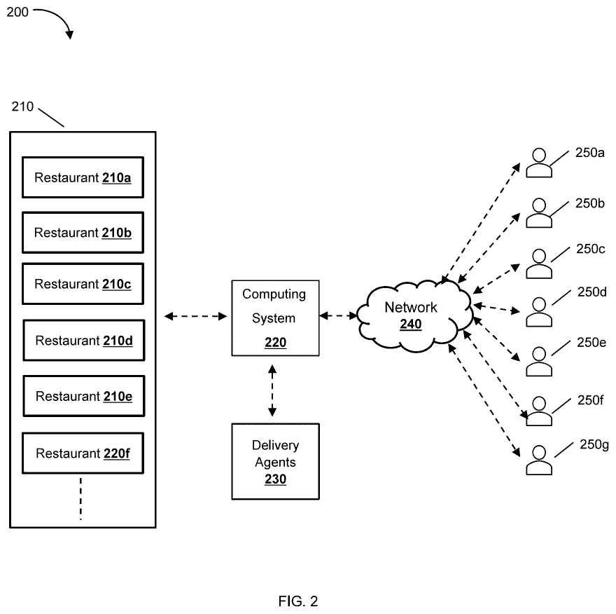

FIG. 2 illustrates an exemplary communication environment 200 between consumers/delivery agents and restaurants, in accordance with some aspects of the present disclosure.

In an aspect of the present disclosure, the communication environment 200 between consumers/delivery agents and restaurants may comprise a plurality of restaurants 210a, 210b, 210c, . . . and a computing system 220 similar to that of the computing system 103 as discussed in above aspects. The computing system 220 may also communicate with the delivery agents for delivering the order placed at the plurality of restaurants 210a, 210b, 210c, . . . .

The communication environment 200 further comprises a number of users/consumers 250a, 250b, 250c, . . . , 250g connected to the computing system 220 or accessing the computing system 220 through their respective one or more electronic devices. The consumers 250a-g may access the computing system 220 via a mobile or web application present on the respective one or more electronic devices.

The consumer 250a-g may place one or more food orders in a restaurant of their choice through the mobile or web application by making a payment to the respective restaurant. If the consumer chooses to pick up the food order on their own, the consumer may set an expected pickup time and/or may provide the access to the GPS location of the consumer once the order is placed. If the consumer prefers a home delivery option, the computing system 220 may send a delivery request to the delivery agents present near the vicinity of the consumer and the delivery agent accepting the delivery request may be provided with the details of the order pickup/drop location and the order details.

In an aspect of the present disclosure, the restaurant may start preparation of the order placed by the consumer based on the pickup time or GPS location of the consumer/the delivery agent coming for pickup of order from the restaurant. The computing system 220 tracks the GPS location of the delivery agent/consumer coming for pickup and instructs the restaurants to start the preparation of the order when the delivery agent/consumer has entered a predefined radius of the restaurant. The predefined radius may be calculated based on the procedure discussed in above aspects.

Thus, the computing system 220 ensures timely delivery/pickup of the order to a consumer ordering the food from the restaurant online without experiencing a commensurate breakdown in texture, taste and consistency of food item.

In an aspect of the present disclosure, a quick response (QR) code is generated for the food order after the payment is received by the computing system 220 or the restaurant. The QR code may be transmitted to the consumer or the delivery agent based on the order pickup/delivery option selected by the consumer. The order may be released to the consumer or the delivery agent only after verification or authentication through the QR code, thereby ensuring food delivery to the customer placing the order.

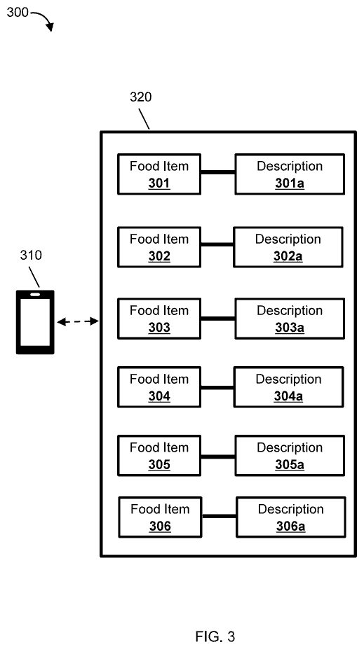

FIG. 3 is a block diagram illustrating an exemplary consumer interaction 300 for placing online food orders, in accordance with an aspect of the present disclosure.

In an embodiment of the present disclosure, the consumer interaction 300 involves consumer interacting with a computing system as discussed in above aspects of the present disclosure. The consumer may access the computing system through one or more electronic devices 310 that may comprise a mobile/web application for accessing the computing system via the communication network such as the internet. The computing system may be a central server, such as cloud server, local server, or a remote server.

In an aspect of the present disclosure, the user interface 320 of the mobile/web application may comprise a list of restaurants and the consumer after the selection of a restaurant from the list of restaurants may be directed to the list of food items and associated description for selecting one or food item based on a preferred cuisine.

In an aspect of the present disclosure, the user interface 320 may show a plurality of food items 301, 302, 303, 304, . . . 306 and their respective description 301a, 302a, 303a, 304a, . . . 306a for ordering one or more food items through the mobile/web application. The consumer, after selection of one or more food items and their respective quantity, may be directed to the transaction page for making the payment and confirming the order. The order may then be picked-up/delivered based on the procedure as discussed in above aspects.

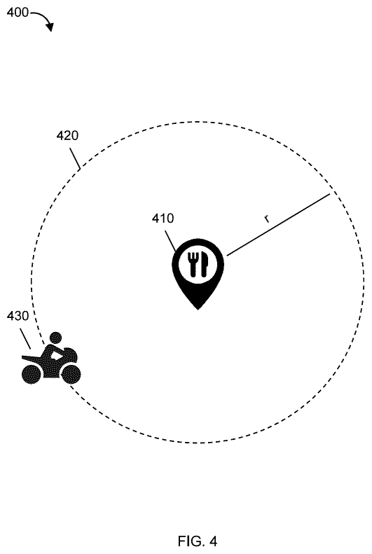

FIG. 4 shows an exemplary environment 400 for tracking real-time GPS location of the consumers/delivery agents, in accordance with an aspect of the present disclosure.

In an aspect of the present disclosure, the consumer/user may place an order through the mobile/web application of the consumer. The consumer after placing the order by making the payment for the order shall choose/select an option between pickup or delivery through the mobile/web application.

If the consumer selects an option of pickup from the restaurant, the mobile/web application may request a pickup time and/or GPS location of the consumer. The consumer may only opt to provide the pickup time if the consumer does not want to share the GPS location and the system may notify the restaurant only based on the pickup time. If the consumer provides the GPS location for tracking, then the tracking is carried out as discussed in below paragraph.

In an aspect, FIG. 4 shows a consumer 430 coming for pickup of the food order. The computing system may track the movement of the consumer 430 and determine whether the consumer 430 has reached/entered a predefined radius of the restaurant 410. The predefined radius ‘r’ may be calculated based on the estimated preparation time of the food order. In response to the consumer entering a region 420 defined by the predefined radius ‘r’, the respective restaurant 410 may be instructed to start the preparation of the order placed by the consumer 430. In one non-limiting aspect, an order ticket is printed by the kitchen printer of the restaurant 410 once the consumer enters the predefined radius of the restaurant 410.

If the consumer selects an option of doorstep delivery, the mobile/web application may request a pickup time from a delivery agent based on the procedure discussed above. The computing system may then request GPS location from the delivery agent for tracking the movement of the delivery agent.

In an aspect, FIG. 4 shows the delivery agent 430 coming for pickup of the order. The computing system may track the movement of the delivery agent 430 and determine whether the delivery agent 430 has reached/entered a predefined radius of the restaurant 410. The predefined radius ‘r’ may be calculated based on the estimated preparation time of the food order. In response to delivery agent 430 entering a region 420 defined by the predefined radius ‘r’, the respective restaurant 410 may be instructed to start the preparation of the order placed by the consumer. In one non-limiting aspect, an order ticket is printed by the kitchen printer of the restaurant 410 once the delivery agent 430 enters the predefined radius of the restaurant 410.

Thus, the real time tracking of GPS location of the consumer/delivery agent ensures timely delivery/pickup of the order to a consumer ordering the food from the restaurant online without experiencing a commensurate breakdown in texture, taste and consistency of food item.

In one non-limiting aspect of the present disclosure, the consumer may be provided real-time updates of the status of the order based on the tracking discussed in above aspects.

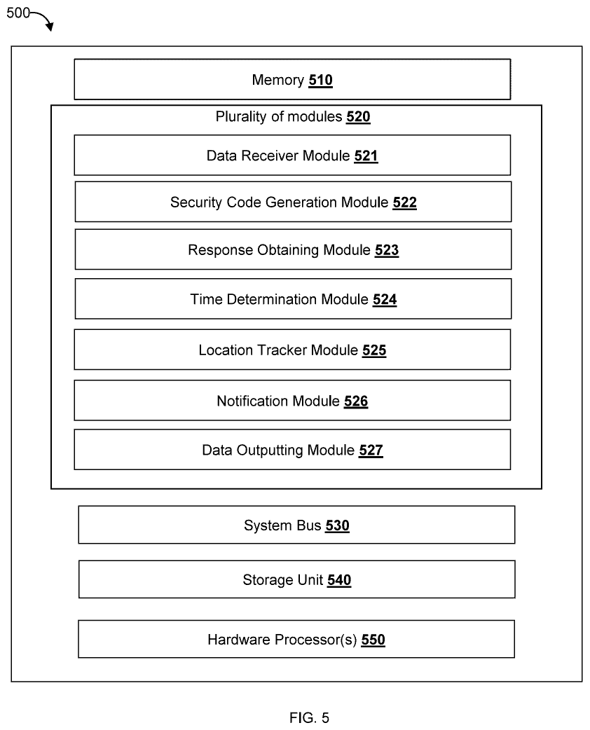

FIG. 5 is a block diagram illustrating a computing system for managing food preparation by restaurants for online food orders, in accordance with an aspect of the present disclosure.

In an aspect of the present disclosure, the computing system 500 may comprise one or more hardware processors 550, a memory 510 and a storage unit 540. The one or more hardware processors 550, the memory 510 and the storage unit 540 are communicatively coupled through a system bus 530 or any similar mechanism. The computing system 550 may further comprise a plurality of modules 520. The plurality of modules 520 includes a data receiver module 521, a security code generation module 522, a response obtaining module 523, a time determination module 524, a location tracker module 525, a notification module 526, and a data outputting module 527.

In one non-limiting aspect, the plurality of modules 520 may be stored in the memory 510 in the form of programmable instructions executable by the one or more hardware processors 550. In another non-limiting aspect, each of the plurality of modules 520 may have their respective specific hardware circuitry required for carrying out the below mentioned functionalities.

The one or more hardware processors 550, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 550 may also include embedded controllers, such as generic or programmable logic devices or arrays, application specific integrated circuits, single-chip computers, and the like.

The memory 510 may be non-transitory volatile memory and non-volatile memory. The memory 510 may be coupled for communication with the one or more hardware processors 550 and the plurality of modules 520, such as being a computer-readable storage medium. The one or more hardware processors 550 may execute machine-readable instructions and/or source code stored in the memory 510. A variety of machine-readable instructions may be stored in and accessed from the memory 510. The memory 510 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present aspect, the memory 204 includes the plurality of modules 520 stored in the form of machine-readable instructions on any of the above-mentioned storage media and may be in communication with and executed by the one or more hardware processors 550.

The storage unit 540 may be a cloud storage or a local file directory within a remote server. The storage unit 540 may store consumer details including Personal Identifiable Information (PII) of the consumer. The PII may be the information used to identify the consumer, such as name and contact information of the consumer. Further, the storage unit 540 also stores the food menu of the restaurant, previous food orders received from the consumer, the predefined food order information and security code generated corresponding to the food order.

The consumer places a food order comprising one or more food items and quantity of the respective one or more food items to the restaurant via the mobile/web application. In an aspect of the present disclosure, the one or more food items are raw, cooked, and processed edible substances. The consumer may also pay for the food order by using the mobile application. Further, the data receiver module 521 may be configured to receive the food order from the consumer. In an aspect, the data receiver module 521 may comprise a user interface.

The security code generation module 522 may be operable to generate a security code corresponding to the received food order. In an exemplary aspect of the present disclosure, the security code may be a Quick Response (QR) code. The generated security code is used to verify the food order at time of pick-up of the food order from the restaurant. The generated QR code is outputted to the one or more electronic devices of the consumer/delivery agent via one or more means. The one or more means may be text, email, a combination thereof and the like. In an aspect of the present disclosure, the consumer may pick-up the food order from the restaurant. In another aspect of the present disclosure, a delivery agent associated with third-party food delivery companies may pick-up the food order from the restaurant on behalf of the consumer and deliver the food order to the consumer.

The response obtaining module 524 may be configured to obtain a response from the consumer on whether the consumer is arriving at the restaurant to pick-up the food order immediately. In an aspect of the present disclosure, when the consumer is not arriving at the restaurant to pick-up the food order immediately, the computing system 500 prompts the consumer via the mobile application to enter pick-up time at which the consumer may be picking-up the food order from the restaurant. In another aspect of the present disclosure, when the consumer is arriving at the restaurant to pick-up the food order immediately, the computing system 500 prompts the consumer via the mobile application to provide access to the location information of the consumer and to keep the location on until the food order is picked-up from the restaurant.

In an aspect of the present disclosure, the mobile application associated with the computing system 500 may work with the third-party food delivery companies. When the consumer desires the food order to be delivered by the third-party food delivery companies, the delivery agent associated with the third-party food delivery companies accepts the food order from the consumer, such that the computing system 500 may receive information including current location from one or more electronic devices of the delivery agent who accepted the delivery request as discussed in above paragraphs.

The time determination module 524 may be configured to determine time taken by the restaurant to prepare the food order based on estimated preparation time mapped to the food item(s) and its respective quantity present in the food order. For example, when the consumer places the food order comprising two burgers and French fries, the time determination module 524 determines that the restaurant may take 7 minutes to prepare the two burgers and French fries based on the estimated preparation time mapped to the items.

In an aspect of the present disclosure, when the consumer/delivery agent is arriving at the restaurant to pick-up the food order immediately, the location tracker module 525 tracks the current location of the consumer/delivery agent via Global Positioning System (GPS) to determine if the consumer/delivery agent has crossed threshold location. The threshold location is a location from which time taken by the consumer or the driver to reach the restaurant is the same as the determined time taken by the restaurant to prepare the food order. In one non-limited aspect, the threshold location may fall on region 420 as shown in FIG. 4

In an aspect of the present disclosure, the notification module 526 may be configured to notify the restaurant to start preparing the food order upon determining that the consumer/delivery agent has crossed the threshold location.

In another aspect of the present disclosure, when the pick-up time is received from the consumer, the notification module 526 may only notify the restaurant to start preparing the food order when the time taken by the consumer to reach the restaurant is the same as the determined time taken by the restaurant to prepare the food order. For example, the consumer places a food order at 8:00 PM and enters the pick-up time of the food order at 8:15 PM. Further, the time determination module 524 determines that the time taken by the restaurant to prepare the food order is 10 minutes. The notification module 526 notifies the restaurant to start preparing the food order at 8:05 PM.

The notification module 526 may notify the restaurant to start preparing the food order by sending an order ticket of the food order to a restaurant printer placed inside the kitchen of the restaurant. The restaurant printer prints the order ticket, such that food preparing staff may start preparing food in accordance with the food order mentioned in the order ticket.

Furthermore, when the food order is prepared by the restaurant, the notification module 526 may notify the consumer or the driver that the food order is prepared via the one or more electronic devices of the consumer. In an exemplary aspect of the present disclosure, the notification module 526 may send a text message, an email or a combination thereof to notify the consumer or the driver that the food order is prepared.

When the customer or the driver reaches the restaurant to pick-up the food order, the notification module 526 may notify the restaurant about the arrival of the consumer or the driver by outputting one or more notifications. In an exemplary aspect of the present disclosure, the one or more notifications may be in the form of a tone played on the restaurant system. In an aspect of the present disclosure, when the consumer selects curbside delivery for the food order, the notification module 526 notifies the restaurant about one or more identifiers of the consumer. The one or more identifiers helps the restaurant to identify the consumer. In an exemplary aspect of the present disclosure, the one or more identifiers include type of vehicle, vehicle model, color of vehicle, location of vehicle of the consumer and the like. In another exemplary aspect of the present disclosure, the consumer/delivery agent is authenticated based on the QR code transmitted to the consumer/delivery agent after an order is placed by the consumer.

The data outputting module 527 outputs a pick-up location to the consumer for picking-up the food order from the restaurant via the one or more electronic devices. In an exemplary aspect of the present disclosure, the pick-up location may be a specific gate, curbside at a specific numbered parking spot, drive-thru of the restaurant or the like. Further, the consumer shows the security code to one or more scanning devices at the restaurant, such that the one or more scanning devices scans the security code and extracts the food order from the security code. Furthermore, the one or more scanning devices confirm the food order placed by the consumer. The food order is released to the consumer upon confirmation of the food order.

In an aspect of the present disclosure, the mobile application associated with the consumer has multiple graphical user interface screens for registration, login, dashboard, menu screen, contact list, profile edit, payment method and the like. The registration screen of the mobile application is used to register the consumer when the consumer is using the mobile application for the first time. There are multiple registration fields and buttons on the registration screen, such as phone number, password, confirm password, gender, email address, confirm email address, date of birth, I agree terms button and submit button. The consumer may also have to add a username while registering. In an exemplary aspect of the present disclosure, the username may be an email address of the consumer. When the consumer clicks on the submit button, an email will be sent to an admin and the consumer as well. The consumer needs to confirm their account by clicking on the verification link sent to their email address and verification code sent by text on the one or more electronic devices. The consumer may also select an option to automatically receive promotions, offers and discounts from the restaurant via email or text. The restaurant may also send an email on the consumer's birthday for a free item.

Further, the login screen of the mobile application is used by the consumer to login by using their username and password chosen at the time of registration. When the consumer logs in for the first time, the mobile application keeps the consumer logged in till the consumer manually logs out. There are multiple login fields and buttons on the login screen, such as username, password, sign in button, forgot password button and sign-up button. When the consumer forgets his password, the consumer has to click on a forgot password button. The consumer has to provide his email address which is used at the time of registration to reset the password. When the consumer provides the email address, the mobile application confirms if any account is associated with the provided email address. When it is confirmed that an account is associated with the provided email address, one e-mail may be sent on the provided email address containing a link to reset the password. Furthermore, the dashboard screen of the mobile application is used by the consumer to access various features and information, such as logo on top, profile picture of the consumer, name of the user, browse food menu of the restaurant, best selling food items, profile edit, setting and sign out.

Furthermore, the menu screen of the mobile application is used by the consumer to browse different food items which he/she desires to order. The consumer is required to add food items into their cart and make payment for the added food items. In the current scenario, the consumer must pay for the food items while placing the food order as cash on delivery option is not available. After payment, the mobile application obtains a response from the consumer on whether the consumer is arriving at the restaurant to pick-up the food order immediately. When the consumer is not arriving at the restaurant to pick-up the food order immediately, the mobile application prompts the consumer to enter pick-up time or pick-up time slot at which the consumer may be picking-up the food order from the restaurant.

When the consumer arrives at the restaurant to pick-up the food order immediately, the mobile application prompts the consumer to turn on the location of the one or more electronic devices and to keep the location on until the food order is picked-up from the restaurant. Further, the mobile application sends a notification to the restaurant manager in his web panel along with the location of the consumer. The mobile application also notifies the restaurant to start preparing the food order upon determining that the consumer/delivery agent has crossed the threshold location or when the time taken by the consumer to reach the restaurant is the same as the determined time taken by the restaurant to prepare the food order. When the consumer selects curbside delivery for the food order, the mobile application notifies the restaurant about one or more identifiers of the consumer, such as color of vehicle and model of vehicle. Furthermore, when the customer reaches the restaurant to pick-up the food order, the mobile application notifies the restaurant about the arrival of the consumer by outputting one or more notifications on the restaurant system. Further, the consumer shows the QR code to one or more scanning devices at the restaurant and pick-up the food order.

Further, the contact list screen of the mobile application is used by the consumer to contact support for any issues or queries. The profile edit screen of the mobile application is used by the consumer to edit their PII, such as a profile picture. Furthermore, the payment method screen of the mobile application is used by the consumer to perform payment of the food order. The payment method screen is integrated using Application programming Interface (API) provided by a current Point of Sale (POS) system.

In an aspect of the present disclosure, the web application associated with the restaurant manager has multiple graphical user interface screens, such as manage user screen, manage menu screen and manage newsletter screen. The manage user screen of the web application is used by the restaurant manager to manage the consumers, such as add, delete and block any consumer. Further, the manage menu screen of the web application is used by the restaurant manager to manage food menus, such as add or delete any food item. The manage menu screen may also be used to change the price of any food item. Furthermore, the manage newsletter of the web application is used by the restaurant manager to send promotional offers to the registered consumer.

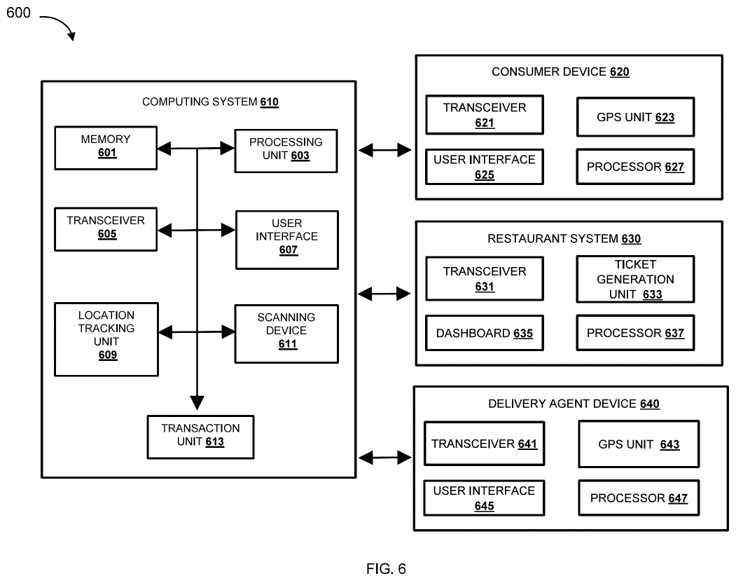

FIG. 6 is a block diagram illustrating a system 600 for managing food preparation by restaurants for online food orders, in accordance with an aspect of the present disclosure.

In an aspect of the present disclosure, the system 600 may comprise a computing system 610, a consumer device, a restaurant system 630, and a delivery agent device 640 communicatively connected with each other over a communication network. In one non-limiting aspect, the communication network may be the internet.

In an aspect of the present disclosure, the computing system 610 may comprise memory 601, processing unit 603, a transceiver, a user interface 607, a location tracking unit 609, a scanning device 611, and a transaction unit 613 in communicatively coupled with each other. The consumer device 620 may comprise a transceiver 621, a GPS unit 623, a user interface 625, and a processor 627 in communication with each other. The restaurant system 630 may comprise a transceiver 631, a ticket generation unit 633, a dashboard 635, and a processor 637 in communication with each other. The delivery agent 640 may comprise a transceiver 631, a GPS unit 643, a user interface 645, and a processor 647 in communication with each other.

However, the hardware/software components of the computing system 610, consumer device, restaurant system 630, and delivery agent device 640 are not limited to above mentioned components and the computing system 610, consumer device, restaurant system 630, and delivery agent device 640 may comprise any other component required to carry out their respective functionalities.

In an aspect of the present disclosure, the memory 601 of the computing system 610 may be operable/configured for storing a plurality of instructions. The processing unit in communication with the memory 601 may be capable of executing a plurality of instructions. The user interface 607 may be configured to receive a food order from at least one consumer over an online food delivery platform. The food order comprises at least one food item and quantity of the at least one food item.

In an aspect of the present disclosure, to receive the food order, the user interface comprising a display unit is configured to display a plurality of restaurants along with respective available food items. The consumer may select a restaurant of his/her choice, one or more food items and their respective quantity. The user interface 607 may be configured to receive the selection of the restaurant, the at least one food item, and the quantity of the at least one food item by the consumer via a mobile application. The processing unit may be then configured to execute a payment for the selected at least one food item and generate a quick response (QR) code for the food order after the payment is received.

In an aspect of the present disclosure, once the order is placed by executing the transaction, the user interface 607 may be configured to receive order pickup information associated with the food order. The order pickup information comprises one or more of: order pickup time, GPS location information of the consumer, and GPS location information of a delivery agent.

In an aspect, to receive order pickup information, the user interface 607 comprising a display unit is configured to display at least an order pickup/delivery option to the consumer. The order pickup/delivery option may comprise at least one of: consumer pickup and one or more available delivery agents. In one non-limiting aspect, the option may only include consumer pickup or doorstep delivery option and the computing system 600 may assign an appropriate delivery agent for the doorstep delivery to the consumer using the procedure discussed in above paragraphs.

The user interface 607 may be configured to receive a selection of one of the order pickup/delivery options from the consumer. If the selection includes a consumer pickup option, then an order pickup time and/or GPS location information of the consumer is received from the user. The GPS location information is received from the GPS unit 623 of the consumer device 620.

In an aspect of the present disclosure, if the selection includes selection of the delivery agent option, the computing system may request a GPS location information from the delivery agent 640. The delivery agent device 640 comprises a GPS unit 643 for capturing the GPS location information of the delivery agent that accepts a food delivery request and transmits the GPS location information to the computing system 600 for tracking.

In an aspect of the present disclosure, the transceiver 605 of the computing system 600 may be configured to transmit the QR code for the food order to the consumer or the delivery agent based on the order pickup/delivery option selected by the consumer. The QR code may be used for authentication of the consumer/delivery agent.

In one non-limiting embodiment of the present disclosure, the consumer and the delivery agent may access the user interface 607 of the computing system 600 through a mobile/web application present on their respective device. In one non-limiting embodiment, the consumer device 620 and the delivery agent device 640 may use their respective user interfaces 625, 645 for capturing one or more information from the consumer and the delivery agent and transmit the information to the computing system 600 via transceiver 621, 641.

After the receipt of the order and the order pickup information, the processing unit 603 may be configured to determine a time period for preparing the food order based on an estimated preparation time of the at least one food item present in the food order. The at least one food item is mapped with an estimated preparation time by the restaurant that is used by the computing system 600 to determine the time period for preparing the order.

The processing unit 603 may be then configured to determine whether to start preparation of the order based on the time period for preparing the food order and order pickup information. To determine whether to start preparation of the order, the processing unit may be configured to determine predefined radius from the restaurant based on the time period for preparing the food order, continuously track a position of the consumer/delivery agent based on the GPS location information of the consumer/delivery agent, and determine whether the consumer or the delivery agent enters in the predefined radius of the restaurant.

In one non-limiting aspect of the present disclosure, the processing unit 603 may be configured to calculate a time period required by the consumer/delivery agent to reach the restaurant based on the tracking of the GPS location information of the consumer/delivery agent and initiate the preparation of the food order if the time left to reach the restaurant matches the time period for preparing the food order.

In another aspect, the consumer may not want to share the location information with the computing system 600, the processing unit 603 may be then configured to initiate the preparation of the order based on a time left for pickup matching the time period for preparing the at least one food order.

In an aspect of the present disclosure, to initiate the preparation of the order, the processing unit 603 is configured to notify the restaurant to start the preparation of the order, if the time left for pickup matches the time period for preparing the food order, and/or if the consumer or the delivery agent enters in a predefined radius of the restaurant, and notify the consumer about the preparation of the order.

Thus, the real time tracking of GPS location of the consumer/delivery agent and comparing the pickup time with the order preparation time ensures timely delivery/pickup of the order to a consumer ordering the food from the restaurant online without experiencing a commensurate breakdown in texture, taste and consistency of food item.

In an aspect of the present disclosure, the processing unit 603 may be configured to notify a pickup point from one or more pickup points to the consumer/delivery agent after the at least is ready for pickup. The one or more pickup points at a specific location, curbside at specific numbered parking spots, or drive-thru. In another aspect, the processing unit 603 may be configured to receive, via the user interface, a selection of a pickup point from one or more pickup points by the consumer/delivery agent and the one or more pickup points a specific location, curbside at specific numbered parking spots, or drive-thru.

In an aspect, the processing unit 603 may be configured to notify an arrival of the consumer/delivery agent at the pickup location to the restaurant system 620 based on the GPS location information of the consumer/delivery agent. In one non-limiting aspect, the scanning device 611 is configured to authenticate the consumer/delivery agent at the pickup point based on a QR code transmitted to the consumer/delivery agent. The order is released to the consumer/delivery agent based on the authentication of the consumer/delivery agent. In an aspect, the scanning device may be installed at the restaurant.

In one non-limiting aspect, the processing unit 603 may be configured to store one or more details associated with the orders for the consumer in the memory. The processing unit 603 may be then configured to analyze the one or more details associated with the orders placed by the consumer to determine consumer preferences, generate one or more recommendations for the consumer based on the determined consumer preferences, and display, via display unit of the user interface, the one or more recommendations on the mobile application installed on the consumer device 620.

In an aspect, the order is placed by a mobile application installed on a device of the consumer. The consumer may have to register on the mobile application using user credentials, and the user credential may comprise one or more of: username, phone number, password, gender, email address, and date of birth. In one non-limiting aspect, the user credentials further comprise bank account details for executing a transaction.

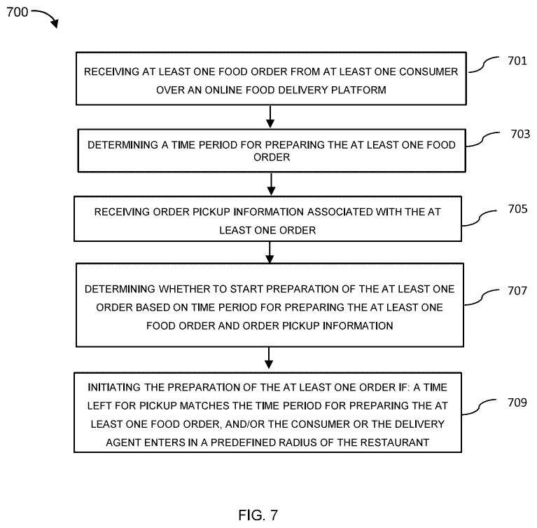

FIG. 7 depicts a flowchart illustrating an exemplary method 700 of managing food preparation by restaurants for online food orders, in accordance with an aspect of the present disclosure.

At step 701, a food order may be received from at least one consumer over an online food delivery platform. The food order comprises at least one food item and quantity of the at least one food item. The food order is received for a restaurant amongst a plurality of restaurants available. In an aspect, receiving the order may comprise displaying a plurality of restaurants along with respective available food items and selecting a restaurant of his/her choice, one or more food items and their respective quantity. The restaurant, the at least one food item, and the quantity of the at least one food item by the consumer via a mobile application. The method may then allow the consumer to make the payment for the order and generate a quick response (QR) code for the food order after the payment is received.

Once the order is placed by executing the transaction, at step 703, a time period for preparing the at least one food order may be determined based on an estimated preparation time of the at least one food item present in the at least one food order. Each of the at least one food item is mapped with an estimated preparation time by the restaurant.

At step 705, order pickup information associated with the food order. The order pickup information comprises one or more of: order pickup time, GPS location information of the consumer, and GPS location information of a delivery agent.

In an aspect, receiving the order pickup information may comprise displaying the order pickup/delivery option to the consumer. The order pickup/delivery option may comprise at least one of: consumer pickup and one or more available delivery agents. In one non-limiting aspect, the option may only include consumer pickup or doorstep delivery option and an appropriate delivery agent for the doorstep delivery may be assigned to the consumer using the procedure discussed in above paragraphs.

The receiving of the order pickup information may comprise selecting one of the order pickup/delivery options by the consumer. If the selection includes a consumer pickup option, then an order pickup time and/or GPS location information of the consumer is received from the user. If the selection includes selection of the delivery agent option, GPS location information from the delivery agent is requested and received. In an aspect of the present disclosure, the method further comprises transmitting the QR code for the food order to the consumer or the delivery agent based on the order pickup/delivery option selected by the consumer. The QR code may be used for authentication of the consumer/delivery agent.

After the receipt of the order and the order pickup information, at step 707, the method 700 may comprise the step of determining a time period for preparing the food order based on an estimated preparation time of the at least one food item present in the food order. The at least one food item is mapped with an estimated preparation time by the restaurant that is used to determine the time period for preparing the order.

The determination of whether to start preparation of the order may comprise determining predefined radius from the restaurant based on the time period for preparing the food order, continuously tracking a position of the consumer/delivery agent based on the GPS location information of the consumer/delivery agent, and determining whether the consumer or the delivery agent enters in the predefined radius of the restaurant.

In one non-limiting aspect of the present disclosure, the method 700 also comprises a step of calculating a time period required by the consumer/delivery agent to reach the restaurant based on the tracking of the GPS location information of the consumer/delivery agent and initiating the preparation of the food order if the time left to reach the restaurant matches the time period for preparing the food order.

In another aspect, the consumer may not want to share the location information, the method 700 may then comprise the step of initiating the preparation of the order based on a time left for pickup matching the time period for preparing the at least one food order.

In an aspect of the present disclosure, initiating the preparation of the order may further comprise notifying the restaurant to start the preparation of the order, if the time left for pickup matches the time period for preparing the order, and/or if the consumer or the delivery agent enters in a predefined radius of the restaurant, and notifying the consumer about the preparation of the order.

Thus, the real time tracking of GPS location of the consumer/delivery agent and comparing the pickup time with the order preparation time ensures timely delivery/pickup of the order to a consumer ordering the food from the restaurant online without experiencing a commensurate breakdown in texture, taste and consistency of food item.

In an aspect of the present disclosure, the method 700 may further comprise the step of notifying a pickup point from one or more pickup points to the consumer/delivery agent after the at least one food order is ready for pickup. The one or more pickup points may be a specific location, curbside at specific numbered parking spots, or drive-thru. In another aspect, the method 700 may comprise the step of receiving a selection of a pickup point from one or more pickup points by the consumer/delivery agent and the one or more pickup points may be a specific location, curbside at specific numbered parking spots, or drive-thru.

In an aspect, the method 700 may comprise the step of notifying an arrival of the consumer/delivery agent at the pickup location to the restaurant system based on the GPS location information of the consumer/delivery agent. In one non-limiting aspect, the method 700 may also comprise the step of authenticating the consumer/delivery agent at the pickup point based on a QR code transmitted to the consumer/delivery agent and releasing the at least one food order to the consumer/delivery agent based on the authentication.

In one non-limiting aspect, the method 700 may store one or more details associated with the orders for the consumer in the memory, analyze the one or more details associated with the orders placed by the consumer to determine consumer preferences, generate one or more recommendations for the consumer based on the determined consumer preferences, and display the one or more recommendations on the mobile application installed on the consumer device.

In an aspect, the order is placed by a mobile application installed on a device of the consumer. The method 700 may comprise the step of registering on the mobile application using user credentials, the user credential comprises one or more of: username, phone number, password, gender, email address, date of birth, and/or bank account details for executing a transaction.

The method 700 may be implemented in any suitable hardware, software, firmware, or combination thereof.

In another non-limiting aspect of the present disclosure, the steps of method 700 may be performed in an order different from the order described above.

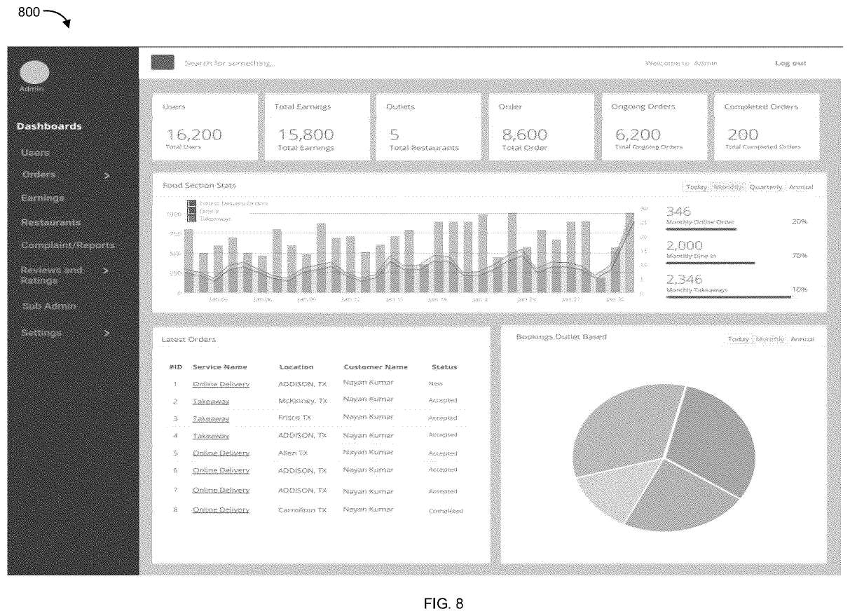

FIG. 8 shows an exemplary dashboard 800 of an administrator of the computing system that maintains an online food ordering/delivery system, in accordance with an aspect of the present disclosure.

The administrator of the computing system discussed in the above aspect may have dashboard 800 for managing the online food ordering/delivery system. The administrator may monitor the users or consumers traffic on the food ordering/delivery system, orders in progress, number of outlets/restaurants available, and orders completed. Further, the administrator may have access to the summary of daily, weekly, monthly, quarterly, and annual earnings/orders of the respective restaurants. The dashboard may also maintain the track of various orders placed over the platform by the consumer. In an aspect, the computing system may analyze the previous orders of the consumers and provide recommendations of restaurants and food items based on the preference of the user.

The dashboard 800 may also provide access to various complaints, reports, and feedback of the consumer. The dashboard 800 may also be used by the administrator to check review and rating of a particular food item and a particular restaurant. The administrator may provide a limited or complete access to one or more sub admins and may monitor the activities of the sub admins through the dashboard. The administrator may add or remove a food item or restaurants from the computing system server.

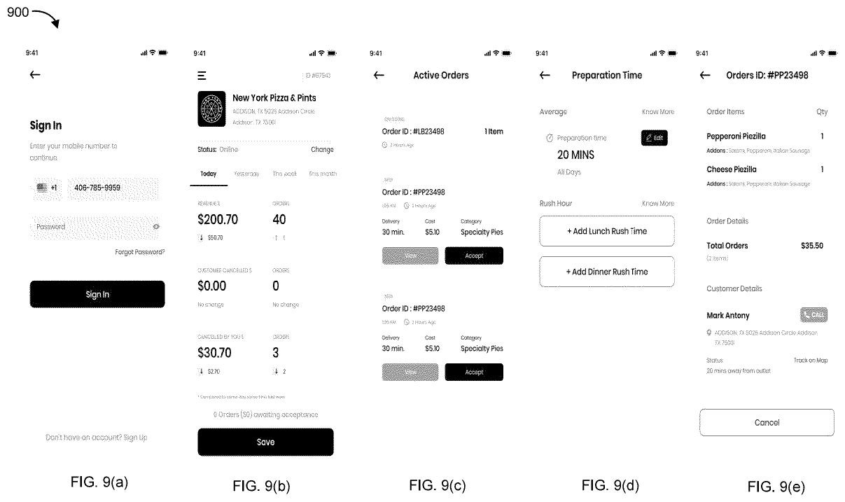

FIG. 9(a)-(e) shows an exemplary application flow 900 for restaurant manager for managing food preparation at a restaurant, in accordance with an aspect of the present disclosure.

FIG. 9(a) shows a sign in page of the mobile/web application installed on the restaurant system. The restaurant manager may sign in on the mobile/web application through a mobile number and a password set by the restaurant manager at the time of setup. However, the sign in method discussed above is not limited and any other sign in/signup procedure known to a person skilled in the art is well within the scope of present disclosure.

FIG. 9(b) shows a summary page of a restaurant that indicates the total revenue, number of orders completed, number of orders canceled by the customer, and also the number of orders canceled or rejected by the restaurant manager and its associated revenue. This information helps the restaurant manager to improve the consumer experience.

FIG. 9(c) shows the active orders along with the respective order IDs to the restaurant manager. The restaurant manager may accept or reject the order based on the availability of the food item order. FIG. 9(d) shows an average preparation time of the order placed by the consumer/user. The restaurant manager may increase or decrease the average preparation time based on the rush hours.

FIG. 9(e) shows an order detail of the order placed by the consumer along with the location tracking information and time left for the arrival of the customer. The restaurant manager may initiate the preparation of the order if the average preparation time of the order is equal to the time left for the arrival of the customer.

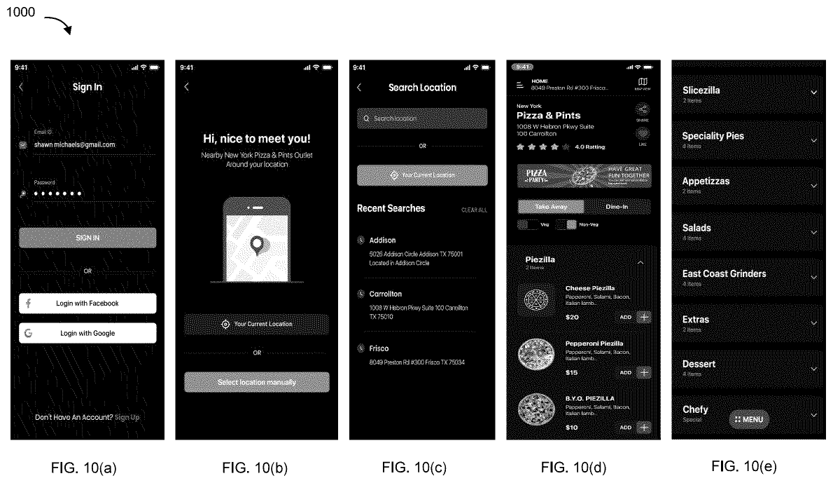

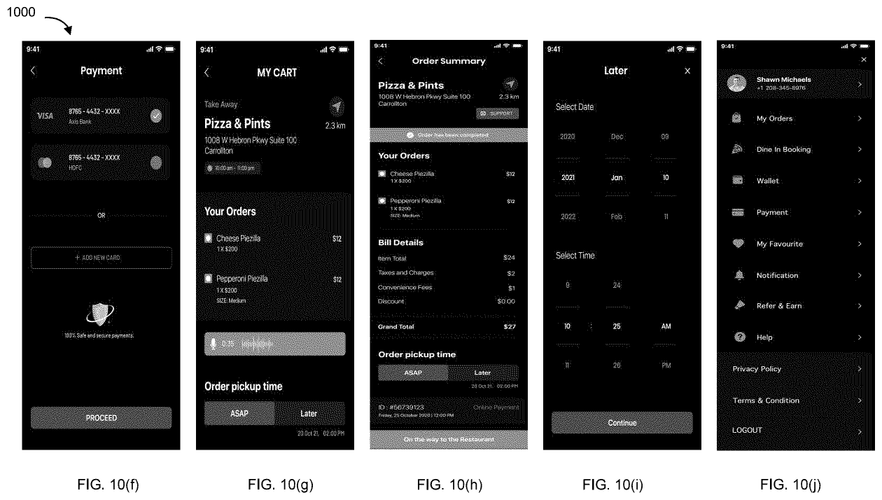

FIG. 10(a)-(j) an exemplary application flow for a consumer accessing an online food ordering platform, in accordance with an aspect of the present disclosure.

FIG. 10(a) shows a sign in page of the mobile/web application installed on a consumer device. The consumer may sign in on the mobile/web application through a mobile number/email and a password set by the consumer at the time of signup. However, the sign in method discussed above is not limited and any other sign in/signup procedure known to a person skilled in the art is well within the scope of present disclosure.

FIG. 10(b) shows a location information page for a consumer to share the current location. The mobile application may display the relevant restaurant near to the current location information of the user once the location information is manually entered or location tab is enabled on the web application.

FIG. 10(c) shows the history of the recent location of consumers from where the consumer has previously accessed the application. This facilitates the consumer to easily access the recent location. FIG. 10(d) shows a restaurant selected by the consumer on the application and the available dishes/food item for selection by the consumer. FIG. 10(e) shows other food options available for order to the consumer.

FIG. 10(f) shows a payment gateway for carrying out the transaction for the selected food items. The payment gateway may also allow the consumer to access the previously added bank account details or saved card details for completing the transaction. The user may enter new bank details or use previously added details for carrying out the transaction.

FIG. 10(g) shows an order completion page, where the consumer is requested to provide specific instruction for an order through audio recording feature. Further, the consumer is presented with an option of selecting a pickup time for the order. FIG. 10(h) shows an option of “as soon as possible (ASAP)” selected by the user for pickup of the order.

FIG. 10(i) shows an option of entering a pickup date and time for the future order which shall be picked up by the consumer later. Thus, the consumer may also place an order in advance and allow the restaurant to prepare the order at a specific time.

FIG. 10(j) shows an application menu shown on the mobile application installed on the device of the consumer. The consumer may review the orders from the “My Orders” tab. The consumer may also do a “Dine in Booking” through the application menu. The consumer may also add money to the wallet of the application for hassle free transactions. The consumer may also add bank details on the payment tab for future transactions. The notification tab of the application may be used by the restaurant to provide the real-time status of the order and any offers for the consumer.

The application flow mentioned in description of FIG. 9(a)-(e) and FIG. 10(a)-(j) is exemplary and any other application flow known to persons skilled in the art is well within the scope of the present disclosure. Further, the mobile/web application shown in FIG. 9(a)-(e) and FIG. 10(a)-(j) may also comprise other features required for placing an order over an online food delivery/pickup platform.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of aspects. Those skilled in the art will appreciate that one or more of the described elements may well be combined into a single functional element. Alternatively, certain elements may be split into multiple functional elements. Elements from one aspect may be added to another aspect. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of aspects is by no means limited by these specific examples.

The aspects herein can comprise hardware and software elements. The aspects that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the aspects may include a hardware configuration of an information handling/computer system in accordance with the aspects herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the aspects herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an aspect with several components in communication with each other does not imply that all such components are required. On the contrary, a variety of optional components are described to illustrate the wide variety of possible aspects of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other aspects of the invention need not include the device itself.

The illustrated steps are set out to explain the exemplary aspects shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed aspects. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items.

The particular embodiments disclosed herein are illustrative only, as the embodiments may be modified and practiced in different but equivalent manners apparent to those skilled in the art having the benefit of the present disclosure. It is therefore evident that the particular embodiments disclosed herein may be altered or modified, and any such variations are considered to fall within the scope of the present application. Accordingly, the protection sought herein is as set forth in the description and the appended claims as well as any other variations and modifications falling within the scope thereof.

What is claimed is:

1. A method of managing food preparation by a restaurant for online food orders, the method comprising:
receiving at least one food order from at least one consumer over an online food delivery platform, wherein the at least one food order comprises at least one food item and quantity of the at least one food item;
determining a time period for preparing the at least one food order based on an estimated preparation time of the at least one food item present in the at least one food order;
receiving order pickup information associated with the at least one food order, wherein the order pickup information comprises one or more of: order pickup time, GPS location information of the consumer, and GPS location information of a delivery agent;
determining whether to start preparation of the at least one food order based on time period for preparing the at least one food order and order pickup information; and
initiating the preparation of the at least one food order if:
a time left for pickup matches the time period for preparing the at least one food order, and/or
the consumer or the delivery agent enters in a predefined radius of the restaurant.

2. The method of claim 1, wherein each of the at least one food item is mapped with an estimated preparation time by the restaurant.

3. The method of claim 1, wherein receiving at least one food order comprises:
displaying a plurality of restaurants along with respective available food items;
selecting the restaurant, the at least one food item, and the quantity of the at least one food item by the consumer via a mobile application;
making a payment for the selected at least one food item; and
generating a quick response (QR) code for the at least one food order after the payment is received.

4. The method of claim 1, wherein receiving order pickup information comprises:
displaying at least order pickup/delivery option to the consumer, wherein the at least order pickup/delivery option comprises at least one of: consumer pickup and one or more available delivery agent;
selecting one of the order pickup/delivery options by the consumer;
receiving an order pickup time and/or GPS location information of the consumer in response to selecting a consumer pickup option; and
receiving GPS location information of the delivery agent that accepts a food delivery request in response to selecting a delivery agent option.

5. The method of claims 3 and 4, further comprising:
transmitting the QR code for the at least one food order to the consumer or the delivery agent based on the order pickup/delivery option selected by the consumer.

6. The method of claim 1, wherein the predefined radius of the restaurant is determined based on the time period for preparing the at least one food order.

7. The method of claim 1, wherein initiating the preparation of the at least one food order comprises:
notifying the restaurant for starting the preparation of the at least one food order if the time left for pickup matches the time period for preparing the at least one food order, and/or if the consumer or the delivery agent enters in a predefined radius of the restaurant, and
notifying the consumer about the preparation of the at least one food order.

8. The method of claim 1, further comprising:
notifying a pickup point from one or more pickup points to the consumer/delivery agent after the at least one food order is ready for pickup, wherein the one or more pickup points are a specific location, curbside at specific numbered parking spots, or drive-thru.

9. The method of claim 1, further comprising:
analyzing the one or more details associated with the at least one food order placed by the consumer to determine consumer preferences;
generating one or more recommendations for the consumer based on the determined consumer preferences; and
displaying the one or more recommendations on a mobile application.

10. The method of claim 1, further comprising:
authenticating the consumer/delivery agent at the pickup point based on a QR code transmitted to the consumer/delivery agent; and
releasing the at least one food order to the consumer/delivery agent based on the authentication.

11. A computing system for managing food preparation by a restaurant for online food orders, the computing system comprising:
a memory for storing a plurality of instructions;
a processing unit in communication with the memory capable of executing a plurality of instructions; and
a user interface in communication with the memory and the processing unit, the user interface configured to:
receive at least one food order from at least one consumer over an online food delivery platform, wherein the at least one food order comprises at least one food item and quantity of the at least one food item, and
receive order pickup information associated with the at least one food order, wherein the order pickup information comprises one or more of: order pickup time, GPS location information of the consumer, and GPS location information of a delivery agent;
wherein the processing unit is configured to:
determine a time period for preparing the at least one food order based on an estimated preparation time of the at least one food item present in the at least one food order,
determine whether to start preparation of the at least one food order based on time period for preparing the at least one food order and order pickup information, and
initiate the preparation of the at least one order if:
a time left for pickup matches the time period for preparing the at least one food order, and/or
the consumer or the delivery agent enters in a predefined radius of the restaurant.

12. The computing system of claim 11, wherein to receive at least one food order, the user interface comprising a display unit is configured to:
display a plurality of restaurants along with respective available food items, and
receive a selection of the restaurant, the at least one food item, and the quantity of the at least one food item by the consumer via a mobile application; and
wherein the processing unit is configured to:
execute a payment for the selected at least one food item; and
generate a quick response (QR) code for the at least one food order after the payment is received.

13. The computing system of claim 11, wherein to receive order pickup information, the user interface comprising a display unit is configured to:
display at least order pickup/delivery option to the consumer, wherein the at least order pickup/delivery option comprises at least one of: consumer pickup and one or more available delivery agent,
receive a selection of one of the order pickup/delivery options by the consumer,
in response to selection of the consumer pickup option, the user interface is further configured to receive an order pickup time and/or GPS location information of the consumer; and
in response to selection of the delivery agent option, the user interface is further configured to receive GPS location information of the delivery agent that accepts a food delivery request.

14. The computing system of claims 12 and 13, further comprising:
a transceiver configured to transmit the QR code for the at least one food order to the consumer or the delivery agent based on the order pickup/delivery option selected by the consumer.

15. The computing system of claim 11, wherein the processing unit is configured to determine the predefined radius of the restaurant based on the time period for preparing the at least one food order.

16. The computing system of claim 11, wherein to initiate the preparation of the at least one order, the processing unit is configured to:
notify the restaurant to start the preparation of the at least one food order, if the time left for pickup matches the time period for preparing the at least one food order, and/or if the consumer or the delivery agent enters in a predefined radius of the restaurant, and
notify the consumer about the preparation of the at least one food order.

17. The computing system of claim 11, wherein the processing unit is configured to:
notify a pickup point from one or more pickup points to the consumer/delivery agent after the at least is ready for pickup, wherein the one or more pickup points are a specific location, curbside at specific numbered parking spots, or drive-thru.

18. The computing system of claim 17, wherein the processing unit is configured to:
analyze the one or more details associated with the at least one food order placed by the consumer to determine consumer preferences,
generate one or more recommendations for the consumer based on the determined consumer preferences, and
display, via a display unit of the user interface, the one or more recommendations on a mobile application.

19. The computing system of claim 11, further comprising:
a scanning device configured to authenticate the consumer/delivery agent at the pickup point based on a QR code transmitted to the consumer/delivery agent, wherein the at least one food order is released to the consumer/delivery agent based on the authentication.

20. A non-transitory computer-readable medium having computer-readable instructions that when executed by a processor causes the processor to perform operations of:
obtaining at least one food order from at least one consumer over an online food delivery platform, wherein the at least one food order comprises at least one food item and quantity of the at least one food item;
determining a time period for preparing the at least one food order based on an estimated preparation time of the at least one food item present in the at least one food order;
obtaining order pickup information associated with the at least one food order, wherein the order pickup information comprises one or more of: order pickup time, GPS location information of the consumer, and GPS location information of a delivery agent;
determining whether to start preparation of the at least one order based on time period for preparing the at least one food order and order pickup information; and
initiating the preparation of the at least one food order if:
a time left for pickup matches the time period for preparing the at least one food order, and/or
the consumer or the delivery agent enters in a predefined radius of the restaurant.
